(19) United States
(12) Patent Application Publication
(10) Pub. No.: US 2008/0175421 A1
(43) Pub. Date: Jul. 24, 2008

(54) INFORMATION DELIVERY

(76) Inventor: Abolghasem Chizari, Cambridge (GB)

Correspondence Address: DUANE MORRIS, LLP;IP DEPARTMENT, 30 SOUTH 17TH STREET, PHILADELPHIA, PA, 19103-4196, US

(21) Appl. No.: 12/019,345

(22) Filed: Jan. 24, 2008

(30) Foreign Application Priority Data
Jul. 26, 2005 (GB) PCT/GB2005/002931

(51) Int. Cl. H04R 25/00; G06F 17/00

(52) U.S. Cl. 381/315; 700/94

(57) ABSTRACT

An information delivery system comprising a transmitter arranged such that it is capable of performing at least one of, receiving a received signal corresponding to an audio signal, which is either a digital signal or which the transmitter is arranged to process into a digital signal; and receiving a digital signal providing information, and the transmitter being arranged to modulate a radio frequency carrier according to either or both digital signals, the system further comprising a receiver arranged to receive the modulated carrier such that the received modulated carrier induces power in the receiver to allow the digital signal to be detected therein, and the receiver being further arranged to allow either or both of the audio signal and the information to be recovered from the detected digital signal.

### FIELD OF THE INVENTION

This invention relates to a method of and apparatus for delivery of information, and concerns in particular, but not exclusively, transmission and reception of audio information from a remote source. Some embodiments of the invention are compatible with hearing aid technology.

### BACKGROUND OF THE INVENTION

There are many situations in which it is desirable to convey information from a source to one or more specific receiving units that are remote from that source. An example is the conveying of sound from a single source to a hearing-aid in the ear of a partially deaf person.

Conventional systems utilize a microphone and speaker closely associated with each other to amplify detected audio information signals and transmit them on to the user. Such amplification can lead to uncomfortable loudness of certain sounds and frequencies while others are too quiet and also to phenomena such as positive feedback, which is manifested as an audible tone at a particular frequency. These methods do not distinguish between wanted sound and unwanted noise. Therefore the problems associated with conventional systems are primarily due to the fact that the audio frequency signals that are being amplified are subject to interference from ambient noise in the user's environment during their propagation, the microphone and speakers are so close and as a result a poorer quality, noisier signal, is thus produced by the user's earpiece.

Some public information delivery systems use an induction loop or T-loop method for communicating to people who are hard of hearing. This method is used in some theatres, in public buildings such as post offices and the like. However these systems are susceptible to magnetic interference, have a short range of operation, are orientation dependent and require large non-portable loop antennae in the transmitter which make it difficult to install and physically large.

Using a carrier such as radio frequency (RF) to deliver the audio information from a wanted source will overcome most of problems associated with the conventional hearing aid systems. This method of audio delivery will increases the range of operation and the quality of received information and also will offer a certain amount of control over the performance of it. It also allows many receivers to listen to one or more transmitters. Systems such as the Conversor™ available from Glentronics, 64 Mallusk Road, Newtownabbey, Northern Ireland, BT36 4QE show examples of such an RF system.

However using conventional radio frequency (RF) technology is not a viable option for certain applications such as hearing aids or any other information delivery system that needs to be, by their nature discreet, and easy to wear on the body. This technology requires high battery power consumption compared to conventional hearing aid technology and it therefore requires large batteries for a reasonable usage time.

DE 195 44 546 shows a hearing aid system in which a digital input is provided such that a digital signal can be input to the aid to improve the sound quality provided to a wearer. However, this document does not disclose an aid that receives a transmitted signal and simply provides a digital input on the hearing aid.

It is known from DE 28 44 979 that a receiver to be worn in the ear can be connected to remote processing electronics held in a pocket or the like and the two connected by a conventional RF radio connection. The RF connection can be used to induce power in the receiver but will require a high power level in order to induce sufficient power in the receiver which may be dangerous to a wearer and may also result in a short battery life in the transmitter. The device shown in this document requires two receivers: a first (23,24) which generates power from the radio signal which powers a second receiver (26) to receive the radio signal. The electronics to provide these receivers may therefore be more complex than is desired.

### SUMMARY OF THE INVENTION

According to a first aspect of the invention there is provided an information delivery system comprising a transmitter unit arranged such that it is capable of performing at least one of,
1. receiving a received signal corresponding to an audio signal which is either a digital signal or which the transmitter unit is arranged to process into a digital signal; and
2. receiving a digital signal providing information,
   and the transmitter unit comprising a digital signal transmitter arranged to modulate a radio frequency (RF) carrier according to either or both digital signals, the system further comprising a receiver unit arranged to receive the modulated carrier such that the received modulated carrier induces power in a digital signal receiver to allow the digital signal to be detected therein and the receiver unit being further arranged to allow either or both of the audio signal and the information to be recovered from the detected digital signal.

An advantage of such a system is that the power consumption of the receiver unit, and of the system as a whole, can be reduced substantially because the carrier is used to induce power therein. As such, battery life may be extended which is advantageous for battery powered application such as hearing aids, and the like. Another advantage of this system is small number of components required to receive the digital radio frequency signal and therefore it can be in a miniature size comparable with hearing aid technology and can be integrated into hearing aids.

Preferably, the digital signal transmitter is arranged to modulate the carrier using an on-off modulation scheme to transmit the digital data. Such a scheme is simple to implement and can be easily detected by the digital signal receiver without consuming any battery power.

Embodiments of the invention may be though of as using semi-active/passive radio frequency technology to overcome the limitations of the conventional RF in information delivery systems such as in hearing aid applications. Semi-active/passive technology is a technique of replacing conventional active components, which are used in radio communication design, with passive and/or semi-active components to receive radio frequency signals at a distance without or with ultra low battery power consumption. Active components consume power and passive components do not and there is boundary between these two, called “semi-active” which may be thought of as having ultra low power consumption. This technique can be more successfully implemented at higher frequency spectrum such as UHF or microwave region as the wavelength is reduced.

The system is preferably arranged such that the digital signal transmitter can interleave the digital signals corresponding to the audio signal and the information. Consequentially it is also preferable that the digital signal receiver is capable of modulating the RF carrier with only one of the digital signals corresponding to either the audio signal or the information. It will be appreciated that if there is no audio signal to transmit then it will be desirable to transmit just information and visa versa.

Indeed, in some embodiments the system may be arranged to monitor the quality of the audio signal recovered, by the digital signal receiver, from the RE carrier. In such embodiments, the system may be further arranged to send only information using the modulated RF carrier if the quality of the recovered audio signal falls below a predetermined threshold.

The system may comprise a conventional radio transmitter and conventional radio receiver (as exemplified by the Conversor™ system described above) which are arranged to be used as a back-up means of transmitting the audio signal. The system may be arranged such that the back-up means is relied upon if the quality of the recovered audio signal falls below a predetermined threshold. Such an arrangement is advantageous because it helps to allow the audio signal to be received at the receiver unit even when conditions are such that the modulated RF carrier does not provide sufficient quality. It will be appreciated from the foregoing that a conventional radio link is undesirable from a power consumption point of view since it will use more power than the modulated RF carrier.

The system may be further arranged to continue transmitting information from the transmitter unit to the receiver unit even when there is not digital signal corresponding to the audio signal being transmitted. It will be appreciated that the quality of the link between the transmitter unit and the receiver unit is not as important when information is being transmitted when compared to an audio signal since the reception of the information is not time critical and there is time to correct errors and/or retransmit the information.

The receiver unit may be arranged such that it can be controlled by the information recovered from the RF carrier. For example, the information may contain control information which specifies how the audio stream should be controlled.

The conventional radio transmitter may be located in the same unit as the digital signal transmitter.

In other embodiments the conventional radio transmitter may be located in a separate unit to the digital signal transmitter. In other embodiments there may be provided a plurality of transmitter units, each containing a digital signal transmitter.

In alternative, or additional embodiments, the transmitter unit may also comprise a conventional radio receiver. In such embodiments the received signal may be received via the conventional radio receiver and subsequently transmitted via the digital signal transmitter.

One or more transmitter units which may be provided by Digital Radio Frequency Transmitting Units (DRFTU) with audio and/or digital inputs, and radio frequency output signals (provided by the modulated carrier). The audio and/or digital inputs are arranged to provide an input for the received signal. The transmitter units/DRFTU are advantageous for conveying source information contained in the received signal in a wireless manner to specific zones/areas in a way that the source information is recovered with relative ease.

The system may be arranged such that the information provided by the digital signal imparts information about any one or more of the following: the specific zone, the source of the audio signal, control information, any other information. As an example of how this may be employed the system may receive information about displays within a museum. In such an arrangement there may be several sources of audio signal (for example one for each display) and the information may provide control information as to which audio signal should be received.

One or more receiver units which may be provided by Digital Radio Frequency Receiving Units (DRFRU) that are capable of receiving the radio frequency signals output by the transmitter unit/DRFTU and recovering the source information contained in the received modulated carrier. Advantageously the receiver units have ultra low power consumption using semi-active/passive RF technology.

### Digital Radio Frequency Transmitting Unit (DRFTU)

The transmitter unit/DRFTU will generally comprise at least some of the following non-exhaustive list: means for information signal input, amplifier, analogue to digital converter, microcontroller, signal processing/compression, modulating technique, radio frequency transmitting unit and transmitting antenna.

The transmitter unit/DRFTU may be arranged such that the received signal (which contains source information) may be from an audio source via directional/omni-directional microphone (or from a socket allowing such a microphone to be connected) or/and audio/digital input sockets from an external device such as television/radio outputs. The source information corresponds to an audio signal from the audio source.

Any input is converted to digital format (if it is not already in a digital format) for signal processing and modulating it on the radio frequency signal (i.e. the carrier). Generally, data compression techniques are used to compress the received signal. However, in some embodiments this need not be used. The or each digital signal may be modulated onto the RF carrier as a series of data packets.

The received signal may be transmitted using a radio frequency pulsing (ON/OFF) transmitter which transmits the radio frequency carrier. In this embodiment the frequency generator signal stay on but the RF power amplifier is turned ON/OFF to generate the modulated carrier.

An appropriate antenna is used to convey/propagate the modulated carrier to specific areas/zones allocated for this application and in which users would be located. Therefore the radiation pattern of the antenna will define the shape of the area/zone covered for the information delivery system. For example a patch antenna with high directivity will beam the information (to a specific zone/area) in a much more focussed manner than an omni-directional antenna that radiates the information in all directions. Therefore by using the right transmitting device a number of zones/area can be created to deliver information to specific group of users in each location that are approximately adjacent to each other without interference with each other.

Microcontroller and software used on the transmitter unit/DRFTU may be arranged to control and define any of the following non-exhaustive list: radio frequency signal (i.e. the modulated carrier), data flow, processing and system sleep-mode techniques to reduce power consumption when no data is transmitted. Suitable analogue to digital converter (ADC), digital signal processing (DSP) and data compression techniques may be selected to ensure that power consumption is as low as possible.

There may be fewer constraints imposed on the transmitter unit/DRFTU compared to receiver unit/DRFRU as generally there are fewer of them used in the system. Further, the transmitter unit/DRFTU may not have to be as portable as the receiver unit/DRFRU.

The transmission method/technique is advantageous in this information delivery system as it reduces the amount of required transmitted data and enable the receiver unit/DRFRU which has more design constraints imposed upon it to recover the source information using ultra low power consumption for short range of communication.

### Digital Radio Frequency Receiving Unit (DRFRU)

The receiver unit/DRFRU, which is generally carried by the users of the system enables them to receive information remote from the source. Advantageously the receiver unit/DRFRU is compatible with existing hearing aid devices. This receiver unit/DRFRU preferably comprises any of the following non-exhaustive list: antenna, a radio frequency receiving unit, a comparator, a microcontroller and software data decompression techniques, digital signal processing, digital output, digital to analogue converter, audio amplifier, an output device and a power source.

There are various types of antennas that can be used to receive the digital radio frequency signal information (i.e. the modulated carrier), however for some applications where the user is moving within the allocated zones/areas the omni-directional antenna may be used as it is less susceptible to transmitter unit/DRFTU directivity.

The receiver unit/DRFRU is preferably designed and tuned in such way that it receives the carrier from the transmitter unit/DRFTU which is then converted to a base-band signal in a single conversion process. Preferably this is performed with ultra low power consumption (i.e. roughly on the order of μA).

The technology used to convert the digital radio frequency information to base-band information with ultra low power consumption is referred to as semi-active/passive technology. This is done by reducing number of active components used or replacing them with semi-active or passive devices that consume no power or less power and can be in a compact size/form and also will cost less to manufacture.

The base-band signal from the digital signal receiver output may be fed through a comparator to convert it to a suitable format for digital signal processing (DSP) and decompression of data. Microcontroller and the software used on the receiver unit/DRFRU may be used to analyse and/or process and/or decompress the recovered data. The receiver unit may be provided with a power saving mode in order to further reduce power consumption in the receiver unit/DRFRU.

An amplifier may be used to amplify the recovered data. The amplifier may be an analogue amplifier and as such a means may be provided to convert the recovered data to an analogue format. Generally the amplifier is arranged to amplify with sufficient level to drive the output device for the user. This receiver unit/DRFRU can have several outputs, providing digital data before and/or after DSP, audio before and/or after amplification. Therefore the device may be made compatible with other external devices such as digital or analogue hearing aid.

When the device is not receiving any data information via the modulated carrier, microcontroller software may be arranged to activate a power saving mode. The receiver unit/DRFRU device may be arranged to initiate different levels of power-saving (which may be referred to as a sleep-mode) depending on the period of time it has not received data information. This technique may provide a further reduction in power consumption and hence increase the efficiency of information delivery system.

In some embodiments the receiver unit may be arranged such that it shuts down in stages. Thus, if a modulated carrier is not received for a first predetermined time then the receiver unit may go into a first state of shut down. If the a modulated carrier is not received for a second predetermined time, longer than the first, then the receiver unit may go into a second state of shut down which has a lower current consumption than the first state. Similarly, there may be further states of shut down. For example, there may 3, 4, 5, 6, 7 or more states of shut down.

Preferably, the receiver unit is arranged such that as soon as a RF carrier is received it wakes up. It will be appreciated that generally, the higher the level of shut down, the longer it will take the receiver unit to wake up but the more power that is saved.

Preferably, the receiver unit comprises a filter such that only an RF carrier of roughly the correct frequency will cause the receiver unit to wake up.

The receiver may be further arranged such that, when an RF carrier of a predetermined frequency is received, a digital “1” is generated. The “1” may be generated by the comparator, or other signal cleaning device, such as a Schmitt trigger, or other logic device. An advantage of such an arrangement when used in conjunction with an On/Off modulation scheme is that a burst of RF carrier at a predetermined frequency can be used to generate a “1” in the receiver. Such an arrangement may provide a compact circuit in which few components are required to provide receive the transmitted signal—fewer components than in a conventional radio receiver. The skilled person will also appreciate that the inverse would equally be possible but it is advantageous to generate a logical “1” since this is likely to be more immune to interference. Such arrangements should mean that the overall power requirement of the system for receiving the signal should be less, may be substantially, when compared to conventional radio reception.

The receiver unit is preferably arranged to be compatible with hearing aids, which may be existing hearing aids. In some embodiments the system may comprise a hearing aid. The hearing aid may be arranged to receive an output of the receiver unit/DRFRU. The output of the receiver unit/DRFRU may be base-band digital or analogue information. The hearing aid may be arranged to concurrently receive other low frequency audio information such as from adjacent surroundings and/or may be switched from receiving the receiver unit/DRFRU output and receiving other low frequency audio information and visa versa.

The preferred operating frequency for this system is in the higher frequency range such as in the UHF and microwave region of the frequency spectrum. Therefore the size of the required antenna would be small enough to be implemented within the receiver unit/DRFRU. In one particular embodiment the operating frequency of the system is roughly 2.4 GHz.

At higher frequencies the increased antenna efficiency obtained by using smaller antennae, combined with the radio frequency technology used in embodiments of the invention, allows the power consumption of the receiver unit/DRFRU (generally provided as an earpiece) to be similar to that of conventional audio amplification systems. Thus improved audio quality and longer range of operation are achieved while maintaining a compact earpiece size. Higher frequency transmission operates in the far field, is therefore less orientation dependent and due to higher antenna efficiencies the range of operation is increased. This means that systems using higher frequencies are easier to install, are less expensive and can be directed to cover a specific area such as a particular region of a theatre (by using an appropriate antenna as discussed above). Higher radio frequencies are preferred because it is possible to transmit a large amount of information—the information that can be transmitted using a radio frequency carrier increases with the frequency of that carrier. Furthermore, as the frequency increases, the length of the required antenna reduces and it becomes easier to implement efficient antennae—hence increasing the range of operation. Lastly, at higher frequencies the signal is less susceptible to possible interference due to lower utilization of higher frequency bands.

According to a second aspect of the invention there is provided a method of delivering an audio signal and/or an information signal comprising receiving a received signal corresponding to the audio signal and/or the information signal, ensuring that the signal is a digital signal, using the digital signal to modulate a radio frequency carrier, transmitting, using a digital signal transmitter, the modulated carrier to a receiver unit, and using the received modulated carrier to induce a current in a digital signal receiver which allows the digital signal to be detected within the carrier and thereafter recovered therefrom.

Such a method is advantageous because it helps to reduce the power consumption in the receiver unit and as such, may lead to a reduced size of receiver (if smaller batteries are used) or an increased battery life.

Further, such a method is also convenient because the digital nature of the signal between the transmitter unit and the receiver unit can help to improve the sound quality received at the receiver unit. It will be appreciated that a digital signal may suffer less from interference compared to an analogue signal.

The method may comprise using ON-OFF modulation as the modulation scheme used to modulate the radio frequency carrier. Such a modulation scheme is advantageous because it is simple to implement and yet provides a convenient mechanism for transmitting the data.

In some embodiments the method may provide the receiver unit as a hearing aid. In alternative, or additional, embodiments the receiver unit may be used to drive a hearing aid. Such methods are convenient because they can lead to greater sound quality for a user of the heating aid.

The method may comprise using a beam shaping antenna within the transmitter unit in order that an area of a predetermined shaped is covered by the modulated carrier. Such a method is convenient because it may be used to provide different source information contained in the original audio signal within defined areas.

The method may comprise using a plurality of transmitter units.

Conveniently, each transmitter unit may have an identity. The method may cause the transmitter unit to add its identity to the digital signal. Such a method is convenient because it allows a receiver unit to receive a signal from a selected transmitter unit that may be selected at the choice of a user.

The method may also comprise using a conventional radio transmitter to transmit the audio signal to the receiver unit if the quality of the audio signal obtained from the modulated carrier transmitted by the digital signal transmitter fall below a predetermined threshold. The method may continue to transmit information using the modulated carrier and digital signal transmitter if a conventional radio transmitter be used to transmit the audio signal.

The information carried by the modulated carrier may be used to control any of the following non-exhaustive list: the receiver unit, a conventional radio receiver, the digital signal receiver.

In one embodiment the information is used to control the frequency to which the conventional radio receiver is tuned. Such a method is convenient because it allows a plurality of receiver units to operate within a locality and yet each receive a different signal by being tuned to a different frequency.

The information signal may provide information as to which transmitter unit should be received by the receiver unit.

The method may comprise broadcasting source information to a plurality of receiver units within an area. Such a method is convenient for broadcasting a performance such a play, a film, a lecture, a lesson or the like to users in an audience.

According to a third aspect of the invention there is provided a transmitter unit arranged such that it is capable of performing at least one of:
1. receiving a received signal corresponding to an audio signal which is either a digital signal or which the transmitter unit is arranged to process into a digital signal; and
2. receiving a digital signal providing information,
   and the transmitter unit being arranged to modulate a radio frequency (RF) carrier according to either or both digital signals

According to a fourth aspect of the invention there is provided a receiver unit arranged to receive a modulated carrier such that the received modulated carrier induces power in a digital signal receiver to allow a digital signal to be detected therein and further arranged to allow either or both of an audio signal and information to be recovered from the detected signal.

According to a fifth aspect of the invention there is provided a program to cause any of the components of the system to function as described herein.

According to a sixth aspect of the invention there is provided a machine readable medium containing instructions which provide a program according to the fourth aspect of the invention.

The machine readable medium may be any of the following non-exhaustive list: a floppy disk, a CD-ROM/RAM, a DVD ROM/RAM (including −R/−RW and +R/+RW), a memory, a hard drive, a transmitted signal (including an Internet download, an ftp transfer or the like), a wire, or any form of storage.

### BRIEF DESCRIPTION OF THE DRAWINGS

Embodiments of the invention will now be described, by way of example only, with reference to the accompanying drawings, in which:

FIG. 1 shows an embodiment of the present invention and its sub-components;

FIG. 2 shows the radio frequency transmitter unit;

FIG. 3 shows the radio frequency receiver unit;

FIG. 4 shows a radio frequency defined field;

FIG. 5 shows the radiation pattern of a patch antenna;

FIG. 6 shows waveforms at various points in the system of the preceding Figures;

FIGS. 7 to 10 show a first example system arrangement for providing an embodiment of the present invention;

FIGS. 11 to 13 show a second example system arrangement for providing an embodiment of the present invention;

FIGS. 14 to 17 show a third example system arrangement for providing an embodiment of the present invention;

FIG. 18 shows the arrangement of two antennas within one embodiment of the invention; and

FIG. 19 shows the arrangement of two microphones that may be used in embodiments of the current invention.

### DETAILED DESCRIPTION OF THE DRAWINGS

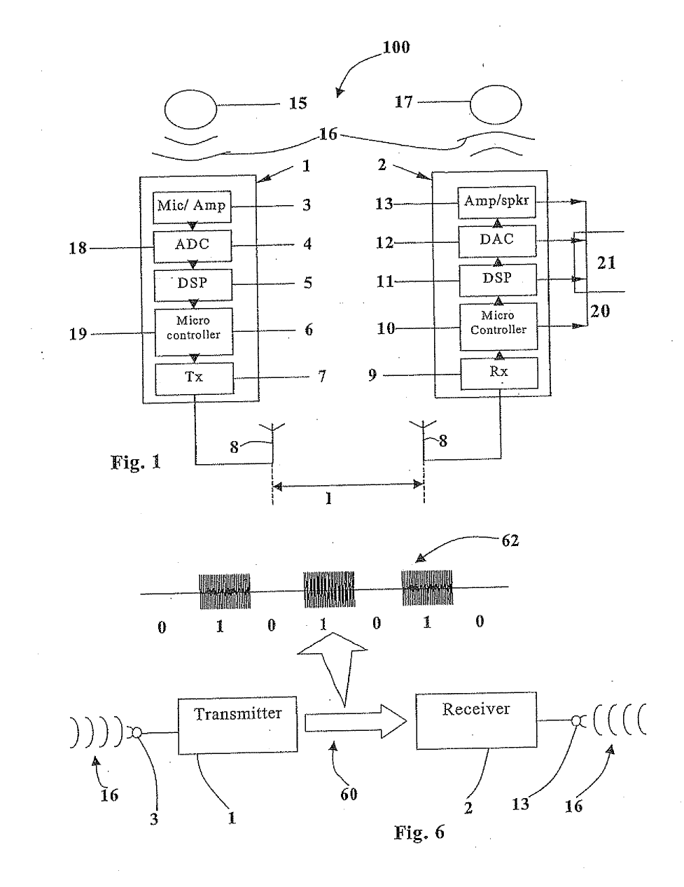

Firstly, referring to FIG. 1, a wireless information delivery system 100 with a Digital Radio Frequency Transmitting Unit 1 (DRFTU) (which can be referred to as a transmitter unit), and Receiving Unit 2 (DRFRU) (which can be referred to as a receiver unit) is shown.

Pressure waves 16 propagate from a sound source 15 to the transmitter unit/DRFTU 1 and from the receiver unit/DRFRU 2 to the desired recipient 17 of the audio information from sound source 15. The desired recipient 17 may be separated from the source 15 by up to the maximum working range 1 of the system 100.

In more detail, a microphone 3 converts the pressure waves 16 into a continuously varying electrical signal (a received signal), which is then converted by the Analogue to Digital Converter 4 into a digital form. The pressure waves contain source information that a user of the system wishes to receive. This digital form is suitable for processing by the Digital Signal Processor 5 and the microprocessor 6 (in this case provided by a microcontroller) (although it should be noted that this processing could easily be performed by a single physical device and they are shown as separate devices to clarify the sequence of operations that the transmitter unit/DRFTU 1 performs on the audio information).

The microcontroller 6 performs two main functions—firstly, it sends data to a digital signal transmitter 7 to instruct it to lock to the correct frequency, and secondly it sends the converted audio information data (i.e. a digital signal) to the digital signal transmitter 7. The digital signal transmitter 7 uses the data from the microcontroller to modulate the RE carrier signal it generates to produce a modulated carrier 60 which can be received by a receiver unit 2. In this embodiment an on-off modulation scheme is used which is exemplified at 62 in FIG. 6.

The digital signal transmitter 7 as shown in FIG. 2 consists of voltage controlled oscillator 22 arranged to generate the radio frequency signal, a buffer amplifier 23 to reduce external influence on the voltage controlled oscillator circuit, a phase lock loop frequency synthesiser 24 to lock the frequency, a power amplifier 25 to generate sufficient transmitted power, a switch to generate pulse or ON/OFF modulation 26 and a band-pass filter 27 to reduce unwanted harmonics of the carrier frequency. It will be appreciated that such ON/OFF modulation is sometimes referred to as ON/OFF keying.

Antennas 8 are used to transmit the RF signal from the transmitter unit/DRFTU 1, and to receive it at the receiver unit/DRFRU 2. The type of antenna 8 used on the transmitter unit and receiver unit could be different.

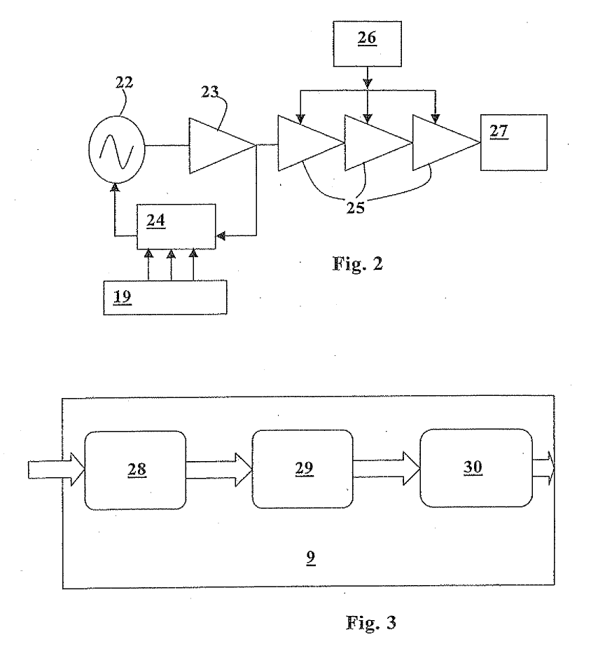

The receiver unit 2 comprises a digital signal receiver 9 which has power induced therein to allow the digital signal to be detected. As shown in FIG. 3 the digital signal receiver 9 performs a direct conversion of radio frequency signal (i.e. the modulated carrier) to baseband and it consist of a band-pass front-end filter 28, a radio frequency detector 29 which is a Schottky diode detector that is tuned to the transmitter unit frequency and a comparator 30 arranged to create a suitable digital signal to feed into the microcontroller 10. The filter 28 is arranged such that only signal at roughly the correct frequency, which in this embodiment is 2.45 GHz, is passed to the radio-frequency detector 29. The filter 28 is advantageous since it helps to reduce noise. Thus, when a signal of the correct frequency is received the comparator 30 outputs a “1” and when no signal of the correct frequency is received the comparator outputs a “0”.

The signal then undergoes digital signal processing using a DSP 11 and is converted to the original form by the Digital to Analogue Converter 12. The output from the Digital to Analogue Converter 12 is amplified to drive a speaker—this may be piezo electric and driven directly, or electro-magnet based and driven using a power amplifier. As with the transmitter unit/DRFTU 1 the DSP 11, the DAC 12 and the micro controller may be provided less than three components and may indeed be provided by a single component.

The range of operation of the system is defined by the range at which valid information may be received from the transmitter unit/DRFTU 1 at the receiver unit/DRFRU 2. This range between the two antennas 8 is shown on the Figure as distance 1 and is determined by the digital signal transmitter 7 power and the digital signal receiver 9 sensitivity.

An example transmitter unit/DRFTU 1 would consist of audio input socket or microphone, operational amplifier, Analogue to Digital Converter (ADC) 4 for example ADC0804LCN, ATMEL Corporation ATTinyl2 microcontroller 6 and a 2.45 GHz ON/OFF radio digital signal transmitter 7. The radio digital signal transmitter 7 consist of L-C voltage control oscillator, buffer amplifier, phase lock loop frequency synthesiser LMX2326 from National Semiconductor, RF power amplifier, switching transistors to modulate the data on the transmitted frequency, band-pass filter and RF connector output.

In a simple example, the function of digital signal processing is carried out by the microcontroller 6 itself. The microcontroller 6 is programmed so that it continuously sends data packets which contain the encoded data, address of the transmitter unit/DRFTU 1 and any other relevant information. There are various antenna options at 2.45 GHz radio frequency, depending on the desired coverage pattern. For example a patch antenna could be used to create a long narrow volume in which the encoded data in the radio signal can be picked up.

The receiver unit/DRFRU 2 may consist of an antenna 8, a radio digital signal receiver 9, a microcontroller 10 and an output device, for example Digital to Analogue converter 12 AD8300. There are microcontrollers with comparator on board such as the ATtiny12 microcontroller from ATMEL Corporation that can be used with ultra low power consumption referred to as sleep mode, entering normal operating mode when an external stimulus occurs. In this case the stimulus would be incoming radio frequency energy making the comparator change state.

An analogue signal 18 from a source other than the microphone 3 could be input to the ADC 4 conveyed wirelessly and retrieved at the output 20 before or after these processes (10, 11, 12, 13) and fed to a hearing aid 21 or any other output device at the output at any of these stages. The skilled person will appreciate that the nature of the signal will vary depending upon where the output signal is taken from. For example, if the output signal is taken from the microcontroller 20 then it will be digital; if the signal is taken from the DSP 11 then it will also be digital; if the signal is taken from the DAC 11 then it is likely to be analogue but at a lower current and if the signal is taken from the amplifier 13 then it will be analogue but is likely to be at a higher current than from the DAC 12. A digital signal 19 in the correct format could be input directly to the transmitter unit/DRFTU 1 microprocessor 6 and retrieved at the receiver unit/DRFRU 2 microprocessor 10.

In some embodiments the micro-controller 6 may be arranged to cause the RF carrier to be modulated with a digital signal that provides information rather than an audio signal. In such embodiments the micro-controller 6 will generally be capable of modulating the RF carrier with both a digital signal corresponding to an audio signal and a digital signal corresponding to information.

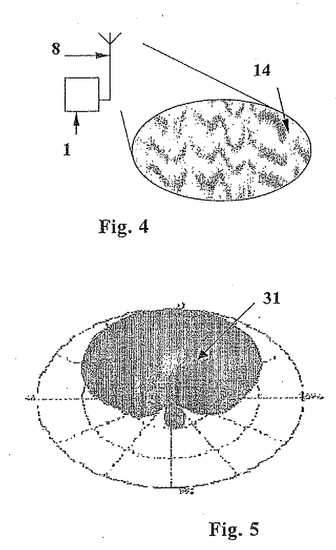

FIG. 4 shows a transmitter unit/DRFTU 1 and antenna 8 generating a radio-frequency field, covering a zone/area 14, 31.

In FIG. 5 the radiation pattern of a patch antenna is shown 31, which is different from an omni-direction antenna's radiation pattern 14. These coverage patterns allow specific regions of space to be selected as zones in which information can be received by the receiver unit/DRFRU 2. It shows the shape of the coverage area 31 generated by a patch antenna.

### An Example of Digital Radio Frequency Transmitting Unit:

An example of a digital radio frequency transmitting unit (DRFTU) could be using a microphone in order to receive a received signal corresponding to an audio signal (directional/omni-directional). Alternatively, or additionally, a socket may be used as an audio or digital input device to receive a signal containing source information. Any received signal would generally be amplified and converted to digital format for digital signal processing (DSP) and compression ready to be modulated on to a radio frequency carrier (a modulated carrier) by a digital signal transmitter 7.

Digital signal processing is advantageous to enhance the quality of the source information provided in the received signal. It will be appreciated that the DSP could be performed on a purpose-made device separate from the microcontroller. The processing may involve filtering to remove unwanted sound components, and/or simple compression algorithms, known to those skilled in the art. For example, μ-law or A-law compression techniques allow reduction of the number of bits needed to represent audio information while maintaining the perceived quality of sound

The 2.45 GHz radio frequency signal is generated using L-C oscillator and the signal is buffered with an amplifier to make it more stable to external influences. The radio frequency signal is set and controlled by a Phase Locked Loop (PLL) synthesiser IC (LMX2326) 24 that allows a frequency to be selected and locked with sufficient accuracy to meet radio device regulatory requirements, and also allows the frequency to be changed in discrete units, which are typically equal to the channel width. The data used to lock the frequency synthesiser IC 24 is stored on the microcontroller 6 and as soon as the transmitter unit is powered the software will download the information required to programme the frequency synthesiser IC 24.

The locked 2.45GHz radio signal is then fed through a RF power amplifier 25 to generated sufficient power for communicating to the receiver unit/DRFRU 2. The range of operation for the information delivery system is up to roughly 10 meters. One possible power amplifier 25 design use Philips transistors BFG425W and BFG21W which is well suited for the new generation low voltage high frequency applications.

In other embodiments the range may be different from 10 meters and may be for example be roughly any of the following non-exhaustive list of distances: 5, 6, 7, 8, 9, 11, 12, 13, 14, 15 or 25 m.

Various modulation techniques can be used to modulate the information on the carrier frequency such as on/off modulation, which best suited for this information delivery system. Alternatively, other modulation may be used such as pulse modulation.

In this transmitter unit example pulse code or ON/OFF modulation technique is used. The digital data information is transmitted by turning the RF power amplifier on and off sufficiently fast to transfer the required data rate.

There are various antennas that can be used to transmit the radio frequency signal and at high frequencies possible antenna types that can be used increases. All antennas have different characteristics and radiation patterns, which will define the shape of the zone/area created to transfer the information. In some situations an omni-directional aerial may be used to achieve the desired coverage pattern, in others the design known to those familiar with the art as a patch antenna may be used to create directional coverage.

For example a 2.45 GHz frequency band patch antenna which is a directional antenna can be used to create a radio frequency zone/area to transmit the information. By using this type of antenna, it is possible to convey the source information to a specific zone/area allocated to specific users or create several zones adjacent to each other without interfering with each other. Since it has a well defined radiation pattern and will create a very specific and directed coverage pattern.

This type of antenna can be easily attached to a ceiling to cover a specific location such as specific area of a theatre/cinema or any other public place for beaming the information to a specific group of users. Therefore it is very easy to install this type of information delivery system.

### An Example of Digital Radio Frequency Receiving Unit:

The receiving unit 2 may be carried by the user to receive wireless information from the transmitter unit/DRFTU 1 and in such embodiments it is desirable by its nature discreet, compatible with hearing aid devices, easy to wear on the body, and ultra-low power consumption. An example of a receiver unit/DRFRU 2 could be using an antenna, front-end filter, a digital radio receiver, comparator, microcontroller/digital signal processing (DSP), digital to analogue converter, audio amplifier, and an output device.

The radio receiving antenna 8 is generally tuned to the digital signal transmitter 7 frequency and there are various possible antenna types that can be used for this application. Generally users of these devices will be moving within the coverage zone/area, and therefore the type of antenna used should tolerate these movements and should not influence the quality of information delivery. In some situations an omni-directional antenna is preferred, since the orientation of the user's head, and hence the aerial itself, should not alter the reception of the radio signals.

The digital signal receiver 9 is designed in such a way that it does not require any battery power, and it is tuned to the operating frequency of the system. The digital signal receiver 9 used is a signal conversion receiver. The digital signal receiver 9 allows the presence of the RF carrier to be detected.

A front-end filter may be used and may be a band pass filter to pass system's transmitter unit radio signal and block all other frequencies signals that might exist within the user environment.

One possible digital signal receiver 9 design is a frequency detector technique to receive pulse-modulated transmitted information. The frequency detector design is based on a conventional Schottky diode detector that requires no bias for high input power level and small DC bias for low input power level to have an ultra-low current consumption, which is in the order of a microampere (μA). The circuit is tuned to the frequency of the digital signal transmitter 7 and a front-end filter is designed using a distributed technique where components are replaced by printed circuit technology. Therefore due to ultra low power consumption this method is defined as semi-active/passive technique. This technology is particularly suitable for short-range devices with a range of approximately 10 meters.

The digital signal receiver's base-band output information is fed through a comparator to create a suitable digital signal for the microcontroller 10 to reconstruct the source information and carryout digital signal processing (DSP) to enhance the quality of the data. The output of the comparator will be a logic ‘1’ if the RF carrier is present and a logic ‘0’ if there is no RF carrier.

The software used on the microcontroller 10 will control all the processes and, in this embodiment, uses sleep mode techniques to reduce power consumption when there is no modulated carrier being received. There may be different sleep-mode levels to reduce power consumption and each sleep-mode level will depend on the time period information is not received. Therefore the microcontroller 10 controls all processes and as soon as it starts to receive information (i.e. starts to receive a modulated carrier), it will initiate the process or wake-up from sleep mode. This technique may allow battery life to be maximized or at least increased.

The digital signal is converted to an analogue signal which will correspond the audio signal received by the transmitter unit/DRFTU 1 and is amplified to drive an output device. Since, in this embodiment, the receiver unit/DRFRU 2 is compatible with hearing aids, the output could be digital or analogue at different stages of receiving process depending on the output device.

In embodiments in which the transmitter unit also modulates the RF carrier with a digital signal providing information then the digital signal receiver is also arranged to recover the information from the RF carrier. Data packets are recovered from the RF carrier in the same manner as the packets which provide the digital signal corresponding to the audio signal, but the receiver unit is arranged to identify the packets and determine that each packet is information rather than a portion of an audio signal.

The output device should be capable of converting analogue signal to sound wave such as piezo-electric device as it requires small electrical current to drive it.

The receiving unit 2 consumes power only for processing the data and converting to analogue output and not for converting radio signal to base-band information; i.e. the RF carrier induces power allowing the digital signal to be detected. This technique become more practical at higher radio frequencies as it is possible to implementation of small and efficient antenna or replacing lump components with a distributed component into the receiver unit/DRFRU 2 which results in an overall compact size allowing the whole unit to be small enough for earpiece integration.

It will be apparent that this embodiments of this invention provide a system that can allow a user to select a source, for example by equipping the transmitter unit/DRFTU 1 with a directional microphone and positioning it in such a way that only the desired source is detected. The transmitter unit/DRFTU 1 may be placed near to a sound source so it picks up sound from that source to the exclusion of other sound sources in the room. It is possible to choose the area in which a user wearing a receiver unit/DRFRU 2 can hear the sound. It can be tailored to the needs of a specific application by using a particular design of antenna, adjusting the power level of the digital signal transmitter 7 or indeed by using several transmitting units in conjunction.

When the transmitting device converts the source information from the source(s) 15 additional information can be included to allow specific receiver units/DRFRU's 2 (or groups of receiver units) to be targeted. The receiver unit/DRFRU 2 may also be instructed to perform additional functions included in the operating software. Such additional processing will allow the source of information to be determined and indicated, as well as the selection of information streams by the receiver unit/DRFRU 2 based on identity of source and destination.

The system 100 is capable of transmitting information from several sources 15 simultaneously. It indicates the identity of the source 15 of each of the information streams to the receiver units/DRFRU's 2, This allows each to be processed or otherwise treated individually. The coding of the data need not simply be an analogue representation of the source information. Well known methods of data compression will allow multiple information streams and control information streams to be simultaneously transmitted, received and decoded or converted to the original form as required. In such manners, the information and audio signal may be multiplexed together and transmitted in the same connection. For example, time division and code division multiplexing are well-understood technologies that could be used to achieve this multiple transmission.

More than one feature may be combined in a single device, for example an analogue to digital converter may be located on a microcontroller.

All or some of the functional components described above may be provided by a single ASIC to reduce power consumption and make it to a compact size.

A suitable application for this invention is in homes, schools, cinemas, theatres and any other private or public places requiring short range information delivery system. The transmitter units/DRFTU's 1 could be placed on the roof, and an antenna type selected to give the desired coverage pattern. The nature of the transmitter units/DRFTU's 2 would allow either for the whole theatre to be covered (may be by using multiple transmitter units/DRFTU's 2) or for coverage of a specific area, to be allocated for the partially deaf. Sound is captured from the stage using radio microphones, amplified, mixed and broadcast using this information delivery system. The sound of the actors' voices would then be accessible to people with suitable receiver units/DRtFRU's 2 in the area covered by a transmitter unit/DRFTU 1.

Many people start to lose hearing sensitivity as they get older—although they would not think of themselves as partially deaf—and would also benefit from embodiments of the invention. It would even be possible to have simultaneous translation of a performance into another language supplied to users, or to otherwise tailor the sound heard, for example with regard to adverts during the interval.

In some embodiments of the invention the transmitter unit 1 comprises a conventional radio transmitter and the receiver unit 2 comprises a conventional radio receiver both of which are provided in addition to the digital signal transmitter 7 and the digital signal receiver 9. In such embodiments the quality of the audio signal that is recovered by the digital signal receiver 9 may be monitored by the microcontroller 10 and if the quality falls below a predetermined threshold transmission of the audio signal is switched from the digital signal transmitter 7/digital signal receiver 9 to the conventional transmitter and receiver. This helps to ensure that the audio signal heard by a user is of sufficient quality but it does increase power consumption in the receiver unit 2.

In such embodiments the digital signal transmitter 7 and the digital signal receiver 9 may continue to transmit a digital signal providing information. The information may include details of the about the source of the audio signal.

The microprocessor 10 may be arranged to process the information and in some embodiments may select the audio signal to be received according to the information. Selection of the audio signal may be by way of frequency selection if the conventional transmitter/receiver is being used, or selection of appropriate packets if the digital signal transmitter 7 and the digital signal receiver 9 are being used.

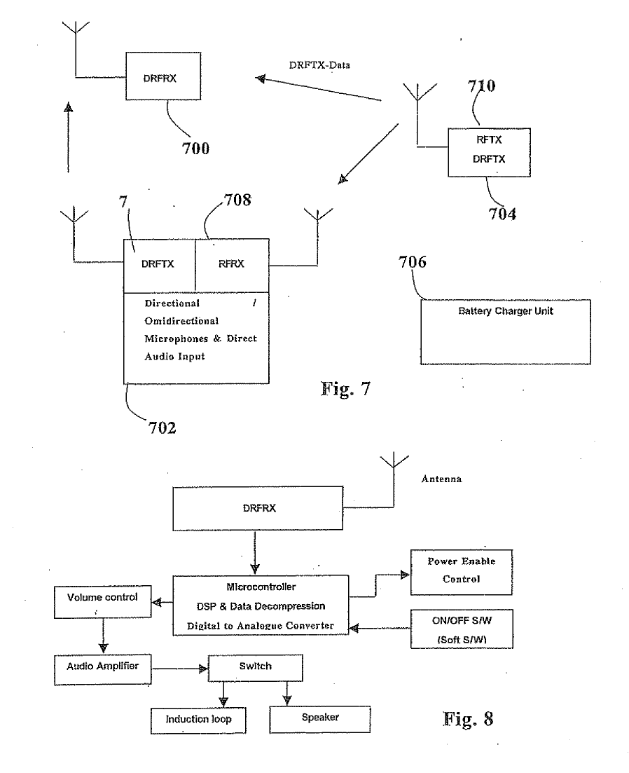

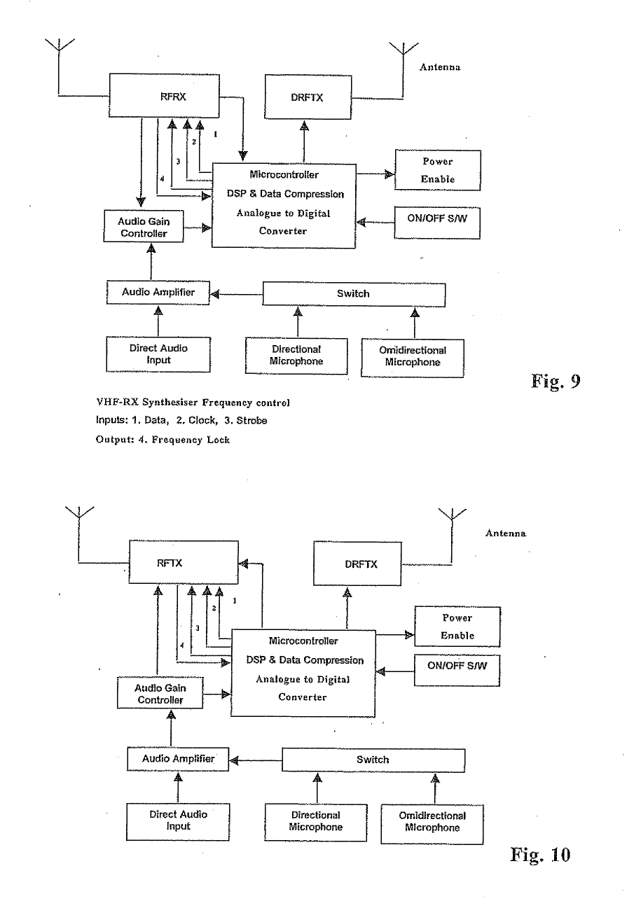

FIGS. 7 to 10 show one possible embodiment of a system in which there is a receiving unit 700, a transmitting unit 702 and a base station 704. A battery charger 706 is also provided in order to charge power sources of any of the receiving unit 700, transmitting unit 702 and base station 704 should these be fitted with rechargeable batteries.

In this embodiment the receiver unit 700 is arranged to be placed on the ear and can receive the modulated radio frequency carrier containing the digital signal providing the information or/and audio signal. The receiving unit 700 is arranged to drive an audio speaker or/and an Induction loop for coupling to a hearing aid such as the T-Loop system.

The transmitting unit 702 is arranged to transmit the modulated radio frequency carrier and it contain audio microphone(s), direct audio input (arranged to accept a digital signal providing information), a conventional radio receiver 708 and the digital signal transmitter 7 arranged to transmit the modulated carrier signal.

The base station 704 will transmit audio/data information using one or more conventional radio frequency transmitters 710 (RFTX) or/and a digital signal transmitter 7 (DRFTX). The base station 704 can be used to increase the range of operation of the system or to send a modulated carrier directly to the receiver Unit 700. A modulated carrier transmitted directly from the base station 704 may contain information that provides information about the allocation of bandwidth (i.e. which frequency the receiver unit 700 should receive), provide location information or the like.

In addition to being able to send a modulated carrier from the digital signal transmitter DRFTX the base station will generally transmit conventional radio signal from the conventional radio transmitter RFTX to the transmitting unit 702. The transmitting unit 702 receives this conventional signal, process the audio signal and/or information therein and transmits from a digital signal transmitter 7 to the receiving unit 700.

FIGS. 8, 9 and 10 provide block diagrams respectively for the receiving unit 700, the transmitting unit 702 and the base station 704.

It will be appreciated that in the embodiment described in relation to FIGS. 7 to 10 the receiving unit 700 does not comprise a conventional radio receiver and only comprises a digital signal receiver 9 (DRFRX). The transmitting unit 702 may be used to extend the range at which the receiving unit 700 can receive the digital signal (the transmitting unit 702 may receive, process and re-transmit the modulated carrier). It is likely that the conventional radio signal transmitted by the conventional radio transmitter RFTX will have a longer range than the signal transmitted by the digital signal transmitter DRFTX and this feature is relied upon in order to increase the range over which the receiving unit 700 can pick up signals transmitted from the base station 704.

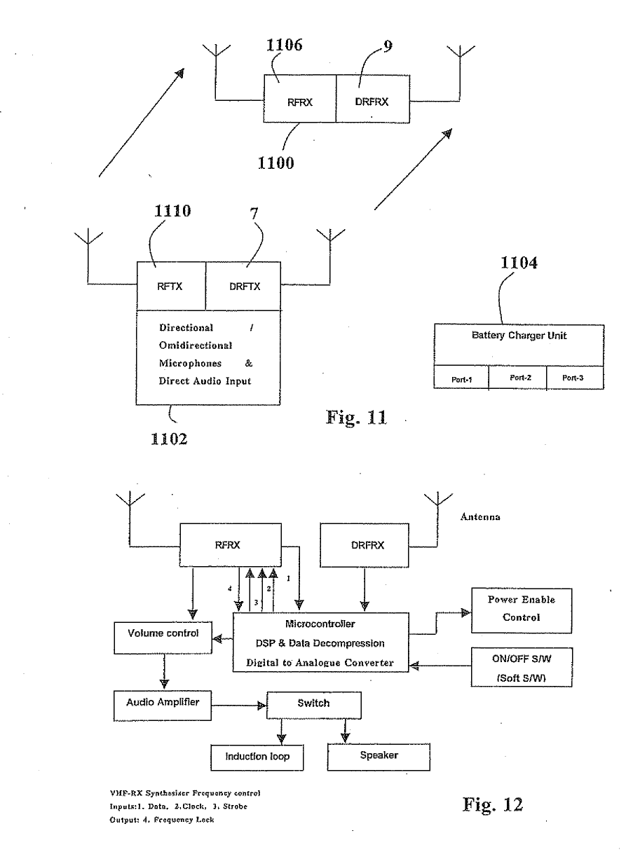

FIGS. 11 to 13 show a second possible embodiment of a system which comprises a receiving unit 1100 and a transmitting unit 1102. Again the system may also comprise a battery charger unit 1104 in order that batteries of either or both of the receiving unit 1100 and the transmitting unit 1104 may be recharged.

In this embodiment the receiving unit 100 comprises both a digital signal receiver 9 and a conventional radio receiver RFRX 1106. In order that the transmitting unit 1102 can communicate with both the digital signal receiver 9 and the conventional radio receiver 1106 it comprises a digital signal transmitter 7 and a conventional radio transmitter 1110. It will be appreciated that the digital signal transmitter 7 generates a modulated carrier which can be received by the digital signal receiver 7 and the conventional radio transmitter 1110 generates a radio signal that can be received by the conventional radio receiver 1106 of the receiving unit 1100.

As described above, the transmitting unit 1102 and the receiving unit 1100 will generally communicate with one another via the modulated carrier. However, if the quality of the audio signal recovered from the modulated carrier falls below a predetermined threshold then the system switches to using the conventional radio transmitter 1110 and receiver 1106.

When the system of this embodiment is using the conventional radio transmitter RFTX and receiver RFRX to transmit audio information between the transmitting unit 1102 and the receiving unit 1100 the digital signal transmitter DRFTX and receiver DRFRX are used to send information from the transmitting unit 1102 to the receiving unit 100. The information can be used to control the functionality of the receiving unit 1100. For example, the information may be used to specify which frequency channel the conventional radio transmitter RFTX and receiver RFRX should use. Thus, if a conflict occurs with another device operating in the vicinity the transmitting unit 1102 may cause the conventional radio transmitter RFTX to change channel and also control the receiving unit 1100 to change channel by sending appropriate control information using the digital signal transmitter. It will be appreciated that the conventional radio transmitter RFTX and receiver RFRX are only used should the quality of the audio signal recovered from the digital signal receiver DRFRX fall below a predetermined threshold.

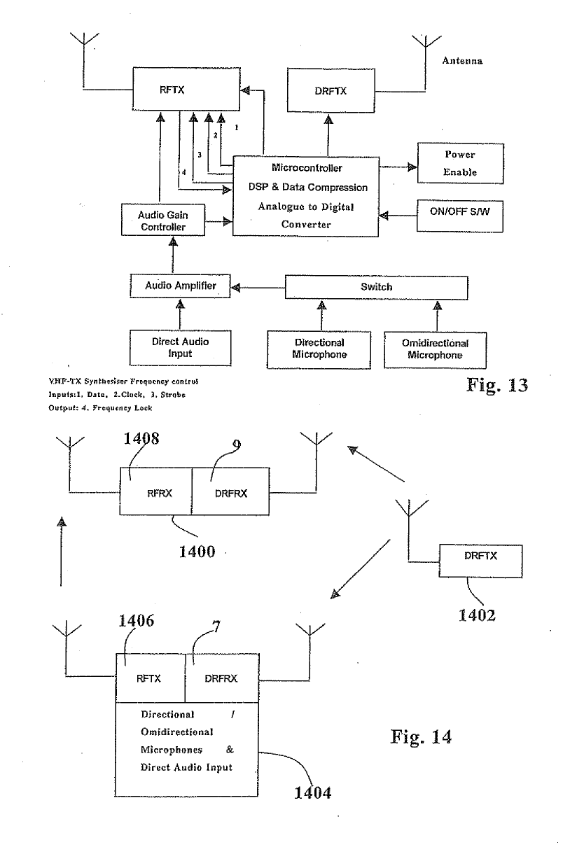

FIGS. 12 and 13 show block diagrams for the components of the receiving unit 1100 and the transmitting unit 1102 respectively.

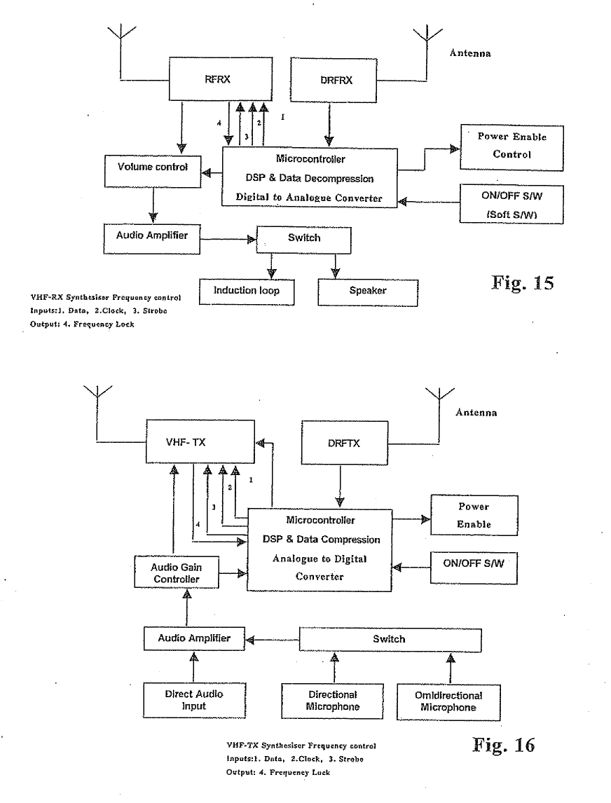

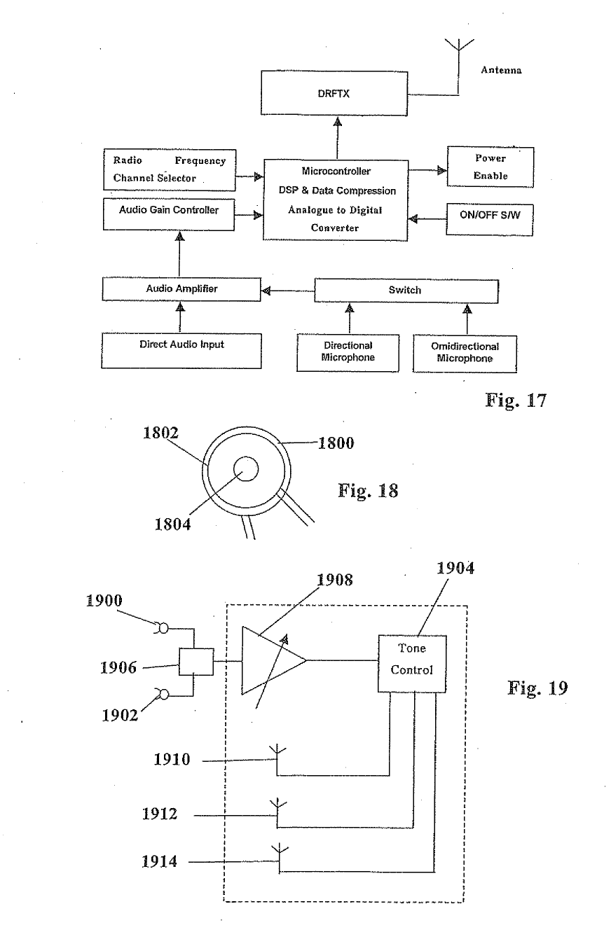

FIGS. 14 to 17 show a third embodiment of the system which comprises a receiving unit 1400, a first transmitting unit 1402 and a second transmitting unit 1404.

The receiving unit 1400 comprises both a digital signal receiver 9 and a conventional radio receiver 1408. The second transmitting unit 1404 comprises both a digital signal transmitter 7 and a conventional radio transmitter 1406.

In use, the receiving unit 1400 is placed on the ear and can receive a conventional radio signal (RFRX) and a modulated carrier (DRFRX) containing the digital signal providing the information or/and audio signal. The modulated carrier can contain location information that can be used to select radio frequency channel allocated to a specific location. The output of the receiver unit 1400 is via an audio speaker or/and an Induction loop for coupling to hearing aid such as the T-loop system.

The second transmitting unit 1404 is arranged to generate a conventional radio signal using a conventional radio transmitter (RFTX) and can receive a modulated carrier using a digital signal receiver (DRFTX) that can contain the digital signal providing the information or/and audio signal. Information within the modulated carrier can comprise location information and can be used to select the radio frequency channel which is used by the conventional radio and possibly allocated to a specific location. The audio signal may be generated from microphones, direct audio input or from digital radio signal (DRFRX) received from the first transmitter unit 1402.

In use of the system the first transmitter unit 1402 is placed in a fixed location, such as on the ceiling of a classroom, or the like. The second transmitter unit 1406 is carried by a user and the receiver unit 1400 is placed in/around a users ear. When a user walks into an area in which the digital signal transmitter DRFTX of the first transmitter unit can be received then the digital signal receiver 9 (DRFRX) of the receiver unit 1400 starts to receive the modulated carrier. As discussed previously the modulated carrier can contain both an audio signal and information used to control operation of the receiver unit 1400. If the quality of the audio signal recovered from the modulated carrier is of an acceptable quality the audio signal is output from the receiver unit 1400 (via either a speaker or an induction loop).

If however, the audio signal is not of sufficient quality then the conventional radio receiver is used to receive a signal, containing an audio signal, transmitted from the second base station 1404. It will be appreciated from FIG. 16 and the description above, that the second transmitter unit 1404 comprises a microphone which is used as an input to the conventional radio transmitter RFTX. Thus, an audio signal is collected by the microphone and transmitted to the receiver unit 1400 via the conventional radio link. As discussed above, the second transmitter unit 1404 and the receiver unit 1400 can select an convenient frequency channel for the conventional radio link using information transmitted from the first transmitter unit 1402.

Thus, all users entering the area covered by the first transmitter unit 1402 (e.g. a class room, museum exhibit) would be able to receive an audio signal therefrom or have their second transmitter unit 1404/receiver unit 1400 pair set up to work in that area.

In some embodiments it may be convenient to provide two transmitting/receiving means such as coils (1800, 1802) which could be used in a variety of arrangements. In one arrangement one of the coils (1800) may function as a Radio frequency receiver and the other coil (1802) may function as an induction coil to inductively couple an audio signal to a remote coil (as for example in a T-loop system). Such an arrangement would be useful to couple the output of the receiver unit to a hearing aid worn by a user. Inductive coupling in this manner is advantageous when compared to generating sound with a speaker since it avoids the possibility of positive feedback occurring in the hearing aid/receiver unit system.

In such an arrangement the receiver unit may also comprise a speaker 1804 which may be provided in a central region of the coils 1800, 1802. A switch may be provided to allow a user to select whether the induction coil 1802, or the speaker 1804 is selected as the output of the receiver unit. Having a speaker is desirable for instances in which a hearing aid worn by a user is not provided with an induction coil (for example is not T-loop compatible).

In the arrangement shown in FIG. 18 the each of the coils 1800, 1802 is provided such that they are wound on top of one another and in this embodiment they are concentric with one another. This need not be the case and the coils could be physically separated from one another. The embodiment shown in FIG. 18 comprises two separate coils but in other embodiments it may be possible to provide a single coil. The coils 1800, 1802 may be provided as tracks on a circuit board (PCB), or a structural technique to provide a transmitting/receiving means as a unitary device suitable to transmit and receive in at least two different frequency ranges. Generally one of the frequency ranges will be for receiving a radio frequency and the other will be for inductively coupling and transmitting to another coil in an audio frequency range.

The arrangement shown in FIG. 18 may provide a convenient arrangement for wearing by a user and 1802 may be worn flat against users ear. The output from the receiver unit (whether from the induction coil 1802 or the speaker 1804) may be used to generate an input for a hearing aid already worn by a user. Alternatively the speaker output could be used as a hearing aid.

In other arrangements only a single coil may be provided which is arranged to function as both an inductive coil (for example for use in a T-loop system) and as a high frequency receiver.

FIG. 19 shows an arrangement in which two microphones 1900, 1902 are connected to a transmitter unit 1904 via a switch 1906. The switch may be a manual switch but is preferably a so-called soft-switch which is under the control of a processing circuitry. The switch 1906 can be used to determine which of the microphones 1900, 1902 (one or the other or both) provides an input to the transmitter unit 1904.

The transmitter unit 1904 may incorporate a tone control which allows a user to tailor the frequencies which are compensated by the hearing aid. The compensation may be by way of amplification in a selected frequency range or may be by way of frequency shifting. Thus, the transmitter may be arranged to optimise processing of a signal for the hearing loss of a user.

The microphone 1900 is an omni-directional microphone and as such can be selected if a user which to capture sounds from a wide range of sources. The microphone 1902 is a directional microphone and can be selected if a user wishes to capture sound from a specific source—such as a person that is speaking. If both microphones 1900, 1902 are selected stereo sound may be generated and/or a user may be able to zoom into any one selected sound source using a gain control on an amplifier 1908 of the transmitter unit 1904.

The transmitter unit also comprises a conventional radio transmitter antenna 1910, a antenna 1912 for transmitting a modulated an RF carrier and an antenna 1914 for receiving a modulated RF carrier. This arrangement will be familiar from the embodiments described above.

1. An information delivery system comprising a transmitter unit arranged such that it is capable of performing at least one of:
1. receiving a received signal corresponding to an audio signal which is either a digital signal or which the transmitter unit is arranged to process into a digital signal; and
2. receiving a digital signal providing information,
and the transmitter unit comprising a digital signal transmitter arranged to modulate, using an on-off modulation scheme, a radio frequency carrier according to either or both digital signals, the system further comprising a receiver unit arranged to receive the modulated carrier such that the received modulated carrier induces power in a digital signal receiver to allow the digital signal to be detected therein and the receiver unit being further arranged to allow either or both of the audio signal and the information to be recovered from the detected digital signal.

2. A system according to claim 1 in which the receiver unit is arranged to generate a logical “1” when a radio frequency carrier of roughly a predetermined frequency is detected.

3. A system according to claim 1 in which the receiver unit constitutes a hearing aid.

4. A system according to claim 1 in which the receiver unit is arranged to generate a signal capable of driving a hearing aid.

5. A system according to claim 1 in which there are a plurality of transmitter units.

6. A system according to claim 1 in which there are a plurality of receiver units.

7. A system according to claim 1 in which the receiver unit comprises a digital signal receiver that is tuned to the carrier transmitted by the transmitter unit.

8. A system according to claim 1 in which the digital signal receiver is arranged to generate a baseband signal from the received modulated carrier.

9. A system according to claim 1 in which is arranged such that the transmitter unit can interleave the digital signals corresponding to the audio signal and the information.

10. A system according to claim 1 in which the transmitter unit is capable of modulating the RE carrier with only one of the digital signals corresponding to either the audio signal or the information

11. A system according to claim 10 which is arranged to monitor the quality of the audio signal recovered, by the receiver unit, from the RE carrier and further arranged to send only information using the modulated RF carrier if the quality of the recovered audio signal falls below a predetermined threshold.

12. A system according to claim 1 in which receiver unit is arranged such that it can be controlled by information recovered from the digital signal providing information.

13. A system according to claim 1 which comprises a conventional radio transmitter and receiver that is arranged to be used as a back-up means of transmitting the audio signal to the receiver unit should the quality of the recovered audio signal fall below a predetermined threshold.

14. A method of delivering an audio signal and/or an information signal comprising receiving a received signal corresponding to the audio signal and/or the information signal, ensuring that the signal is a digital signal, using the digital signal to modulate, using an ON-OFF modulation scheme, a radio frequency carrier, transmitting, using a digital signal transmitter, the modulated carrier to a receiver unit, and using the received modulated carrier to induce a current in a digital signal receiver which allows the digital signal to be detected within the carrier and thereafter recovered therefrom.

15. A method according to claim 14 in which information recovered from the information signal is used to control the receiver unit.

16. A method according to claim 14 in which a digital signal is generated by the receiver unit according to whether or not the radio frequency carrier is detected.

17. A method according to claim 14 which comprises providing the receiver unit as a hearing aid or in which the receiver unit is arranged to drive a hearing aid.

18. A method according to clam 14 which comprises using a beam shaping antenna within the transmitter unit in order that an area of a predetermined shaped is covered by the modulated carrier.

19. A method according to claim 14 in which a plurality of transmitter units are used.

20. A method according to claim 14 in which uses a conventional radio transmission to transmit the audio signal should the quality of the recovered audio, from the digital signal, fall below a predetermined threshold.

21. A transmitter unit for use in the system of claim 1 arranged such that it is capable of performing at least one of:
1. receiving a received signal corresponding to an audio signal which is either a digital signal or which the transmitter unit is arranged to process into a digital signal, and
2. receiving a digital signal providing information,
and the transmitter unit being arranged to modulate, using ON-OFF modulation, a radio frequency (RF) carrier according to either or both digital signals.

22. A receiver unit for use with the transmitter unit of claim 21 which is arranged to receive an ON-OFF modulated carrier such that the received modulated carrier induces power in a digital signal receiver to allow a digital signal to be detected therein and further arranged to allow either or both of an audio signal and information to be recovered from the detected signal.

23. A receiver unit according to claim 22 which is a hearing aid, or which is arranged to drive a hearing aid.

24. A program arranged to run on a transmitter unit for use in the system of claim 1 arranged such that it causes the transmitter unit to perform at least one of:
1. receiving a received signal corresponding to an audio signal which is either a digital signal or which the transmitter unit is arranged to process into a digital signal; and
2. receiving a digital signal providing information,
and the program further being arranged to cause the transmitter unit to modulate, using ON-OFF modulation, a radio frequency (RF) carrier according to either or both digital signals.

25. A program arranged to run on a receiver unit for use with the transmitter unit of claim 21 which is arranged to receive an ON-OFF modulated carrier such that the received modulated carrier induces power in a digital signal receiver and allows a digital signal to be detected therein and wherein the program is arranged to allow either or both of an audio signal and information to be recovered from the detected signal.
